(19) United States
(12) Patent Application Publication
(10) Pub. No.: US 2017/0345072 A1
(43) Pub. Date: Nov. 30, 2017

(54) METHOD FOR PROVIDING ELECTRONIC COMMERCE SERVICE USING CONNECTION BETWEEN SERVICE USE INFORMATION OF MULTIPLE PURCHASERS

(71) Applicant: Gil Hoon CHANG, Seoul (KR)

(72) Inventor: Gil Hoon CHANG, Seoul (KR)

(21) Appl. No.: 15/533,179

(22) PCT Filed: Dec. 3, 2015
(86) PCT No.: PCT/KR2015/013180

§ 371 Date: Jun. 5, 2017

(30) Foreign Application Priority Data
Dec. 5, 2014 (KR) 10-2014-0173695

(51) Int. Cl. G06Q 30/06; G06Q 20/20

(52) U.S. Cl. CPC G06Q 30/0609; G06Q 20/206; G06Q 30/0641

(57) ABSTRACT

An electronic commerce service configured to achieve safe ordering and payment using the connection between service use information of multiple purchasers. Operations include receiving service use information of one user, searching for whether there is another user whose service use information has a connection with the user whose service use information has been received, or requesting a server to search for whether there is another user whose service use information has a connection with the user whose service use information has been received. In addition, operations include receiving the corresponding search result, and when there is another user whose service use information has a connection with the user, adjusting, by one or more levels, a security procedure for service use of the another user whose service use information has a connection with the user or maintaining the level of the security procedure.

### CROSS-REFERENCE TO RELATED APPLICATIONS

This application is a national stage application of PCT/KR2015/013180, filed Dec. 3, 2015, which claims priority to Korean application 10-2014-0173695 filed Dec. 5, 2014, the entire contents of which are incorporated herein by reference for all purposes.

### TECHNICAL FIELD

The present invention relates to a method of providing an electronic commerce service, and more particularly, to a method of providing an electronic commerce service which enables safe ordering and payment and mobile banking using a service use information relationship between a plurality of purchasers.

### BACKGROUND

At sales places, electronic wallets which operate in portable electronic devices are used to make payments for goods and services and used for banking services. Also, it is possible to make orders and payments at sales places using various kinds of electronic commerce software.

Due to characteristics of an electronic wallet corresponding to software, that is, because a third party who is not a person authorized to use the electronic wallet can access and illegally use the electronic wallet in various ways and a limit of usable amount of money is processed in a software manner, enormous damage can be caused when an accident occurs. Therefore, a payment process necessarily involves a personal verification procedure for verifying whether a payment is made using an electronic wallet which is owned and authorized to be used by the user. In many cases, a user is required to input a personal identification number (PIN), such as a password, that only the owner knows, or it is determined whether a user's own electronic wallet is used by himself or herself using biometric recognition technology, such as fingerprint recognition, etc. in terms of security and safe payment.

This is a personal verification procedure that is not essential for conventional payment methods, that is, a cash payment and a credit card payment, or degrades usability. Since damage caused by an accident can be enormous, the personal verification procedure is essential in spite of the degradation of usability unless there is another replaceable method for security enhancement and safety.

### SUMMARY

According to aspects of the present invention, if acquaintances are connected as a plurality of purchasers at a field when an order and a payment are made in an electronic transaction for an offline purchase using an electronic wallet, one of the acquaintances can be a representative settlement person to reduce or adjust a personal verification procedure. It is unnecessary for each of the plurality of purchasers to perform a personal verification procedure together with a seller, and particularly, a personal verification procedure of a payment step in a plurality of purchase procedures can be adjusted by indirect identification such as confrontation or field meeting of the plurality of acquaintances. Also, when a purchaser manually inputs information required for several purchases in a purchase procedure, purchase information context of a plurality of purchasers which is shared among acquaintances connected to each other is identified, and when input information deviating from the purchase information context is found, the purchaser is caused to check the input information, or a deviation from the context is visually represented to help a safe payment.

### BRIEF DESCRIPTION OF DRAWINGS

FIG. 1 is a block diagram of an apparatus and a server for providing an electronic commerce service according to an exemplary embodiment of the present invention.

FIG. 2 is a flowchart of a method of providing an electronic commerce service according to an exemplary embodiment of the present invention.

FIGS. 3 to 7 are flowcharts of methods of providing an electronic commerce service according to other exemplary embodiments of the present invention.

### DETAILED DESCRIPTION

The present invention is directed to providing a method of providing an electronic commerce service which enables safe ordering and payment using service use information relationships between a plurality of purchasers.

The present invention is also directed to providing an apparatus and server for providing an electronic commerce service which enables safe ordering and payment using service use information relationships between a plurality of purchasers.

One aspect of the present invention provides a method of providing an electronic commerce service, the method including: receiving service use information of one service user; and searching for another service user who has a service use information relationship with the service user whose service use information has been received, or requesting a server to search for another service user who has a service use information relationship with the service user whose service use information has been received and receiving a corresponding search result, wherein when there is another service user who has a service use information relationship, a security procedure for service use of the service user who has the service use information relationship is adjusted by one or more steps or maintained.

According to another embodiment of the present invention, the service use information relationship may be set between service users who can be determined as one group service users.

According to another embodiment of the present invention, the service use information relationship may be set between service users when the service users are determined to have used a group service, to have been registered in each other's contact lists, to be located together at a service provision place in the same timeslot, or are determined by themselves to have the service use information relationship with each other, or the service use information relationship may be set between service users when the service users have used the service at one or more common service provision places and use of the service at the places corresponds to use of a group service.

According to another embodiment of the present invention, a correlation analysis on whether places where the service is used in the same timeslot are identical may be performed on the basis of the service users' histories of use of the service, and when a result value derived from the correlation analysis is a threshold value or more, the service use information relationship may be set between the service users.

According to another embodiment of the present invention, the correlation analysis may be performed through a Cohen's Kappa analysis.

According to another embodiment of the present invention, the security procedure for service use may be adjusted by omitting or adding one or more personal verification procedures for one or more of the service users having the service use information relationship.

Another aspect of the present invention provides a method of providing an electronic commerce service, the method including: receiving a request to search for another user who has a service use information relationship with a service user whose service use information has been received from an electronic commerce service provision apparatus; searching for another user who has a service use information relationship with the service user; and transmitting a result of the search to the electronic commerce service provision apparatus, or when there is another service user who has the service use information relationship, adjusting a security procedure of service use of the service user who has the service use information relationship by one or more steps or keeping the security procedure.

Another aspect of the present invention provides a method of providing an electronic commerce service, the method including: receiving service use information of one service user; and searching for another service user who has a service use information relationship with the service user whose service use information has been received, or requesting a server to search for another service user who has the service use information relationship with the service user whose service use information has been received and receiving the corresponding search result, wherein when there is another service user who has the service use information relationship, it is determined whether an error is in the received service use information using a service use information prediction value derived from service use information of the service users who have the service use information relationship.

According to another embodiment of the present invention, the method may further include, when it is determined that an error is in the received service use information, requesting the service user corresponding to the service use information determined to have the error to check the service use information or re-input service use information.

According to another embodiment of the present invention, the method may further include, when it is determined that an error is in the received service use information, adjusting a security procedure of the service user corresponding to the service use information determined to have the error by one or more steps or maintaining the security procedure.

According to another embodiment of the present invention, the service use information prediction value may be derived through a T-test or an analysis of variance (ANOVA) test.

Another aspect of the present invention provides a method of providing an electronic commerce service, the method including: receiving a request to search for another user who has a service use information relationship with a service user whose service use information has been received from an electronic commerce service provision apparatus; searching for another user who has the service use information relationship with the service user; and transmitting a result of the search to the electronic commerce service provision apparatus, or when there is another service user who has the service use information relationship, determining whether an error is in the received service use information using a service use information prediction value derived from service use information of service users having the service use information relationship.

Another aspect of the present invention provides an apparatus for providing an electronic commerce service, the apparatus including: a communication unit configured to receive service use information of one service user or transmit a request to a server to search for another service user who has a service use information relationship with the service user whose service use information has been received and receive the corresponding search result; and a processing unit configured to search for another service user who has the service use information relationship with the service user whose service use information has been received, or request the server to search for another service user who has the service use information relationship with the service user whose service use information has been received, wherein when there is another service user who has the service use information relationship, a security procedure for service use of the service user who has the service use information relationship is adjusted by one or more steps or maintained, and the service use information relationship is set between service users who can be determined as one group of service users.

Another aspect of the present invention provides an apparatus for providing an electronic commerce service, the apparatus including: a communication unit configured to receive service use information of one service user or transmit a request to a server to search for another service user who has a service use information relationship with the service user whose service use information has been received and receive the corresponding search result; and a processing unit configured to search for another user who has the service use information relationship with the service user whose service use information has been received or request the server to search for another user who has the service use information relationship with the service user whose service use information has been received, wherein when there is another service user who has the service use information relationship, it is determined whether an error is in the received service use information using a service use information prediction value derived from service use information of the service users who have the service use information relationship, and the service use information relationship is set between service users who can be determined as one group of service users.

Another aspect of the present invention provides a server for providing an electronic commerce service, the server including: a communication unit configured to receive a request to search for another service user who has a service use information relationship with a service user whose service use information has been received from an electronic commerce service provision apparatus and transmit a result of the search to the electronic commerce service provision apparatus; and a processing unit configured to search for another service user who has the service use information relationship with the service user, wherein when there is another service user who has the service use information relationship, a security procedure for service use of the service user who has the service use information relationship is adjusted by one or more steps or maintained, and the service use information relationship is set between service users who can be determined as one group of service users.

Another aspect of the present invention provides a server for providing an electronic commerce service, the server including: a communication unit configured to receive a request to search for another service user who has a service use information relationship with a service user whose service use information has been received from an electronic commerce service provision apparatus and transmit a result of the search to the electronic commerce service provision apparatus; and a processing unit configured to search for another user who has the service use information relationship with the service user, wherein when there is another service user who has the service use information relationship, it is determined whether an error is in the received service use information using a service use information prediction value derived from service use information of the service users who have the service use information relationship, and the service use information relationship is set between service users who can be determined as one group of service users.

According to the present invention, if acquaintances are connected as a plurality of purchasers at a field when an order and a payment are made in an electronic transaction for an offline purchase using an electronic wallet, one of the acquaintances can be a representative settlement person to reduce or adjust a personal verification procedure. It is unnecessary for each of the plurality of purchasers to perform a personal verification procedure together with a seller, and particularly, a personal verification procedure of a payment step in a plurality of purchase procedures can be adjusted by indirect identification such as confrontation or field meeting of the plurality of acquaintances. Also, when a purchaser manually inputs information required for several purchases in a purchase procedure, purchase information context of a plurality of purchasers which is shared among acquaintances connected to each other is identified, and when input information deviating from the purchase information context is found, the purchaser is caused to check the input information, or a deviation from the context is visually represented to help a safe payment.

Before describing details of the present invention, outlines of solutions to the problems to be solved by the present invention or the core of technical spirit will be provided first for convenience of understanding.

A method of providing an electronic commerce service according to an exemplary embodiment of the present invention includes a step of receiving service use information of one service user, and a step of searching for another service user who has a service use information relationship with the service user whose service use information has been received, or requesting a server to search for another service user who has the service use information relationship with the service user whose service use information has been received and receiving the corresponding search result. Here, when there is another service user who has the service use information relationship, a security procedure for service use of the other service user who has the service use information relationship is adjusted by one or more steps or maintained.

The service use information may include at least one of a user identifier (ID), service session connection information of the user, a user group ID, user order information, user payment information, user location information, banking information of the user, banking use information of the user, and banking use request information of the user.

The electronic commerce service may include an electronic payment service and a banking service.

Hereinafter, embodiments that can be easily performed by those of ordinary skill in the art to which the present invention pertains will be described in detail with reference to the accompanying drawings. However, these embodiments are only for the purpose of describing the present invention in further detail, and it is apparent to those of ordinary skill in the art that the scope of the present invention is not limited by these embodiments.

Configurations of the invention for clarifying solutions to the problems to be solved by the present invention will be described in detail on the basis of exemplary embodiments of the present invention with reference to the accompanying drawings. It is noted in advance that when necessary for describing a drawing, it is possible to quote a component of another drawing. In detailed description of the operational principle of an exemplary embodiment of the present invention, when it is determined that detailed description of a well-known function or configuration related to the present invention and all other matters unnecessarily obscure the gist of the present invention, the detailed description will be omitted.

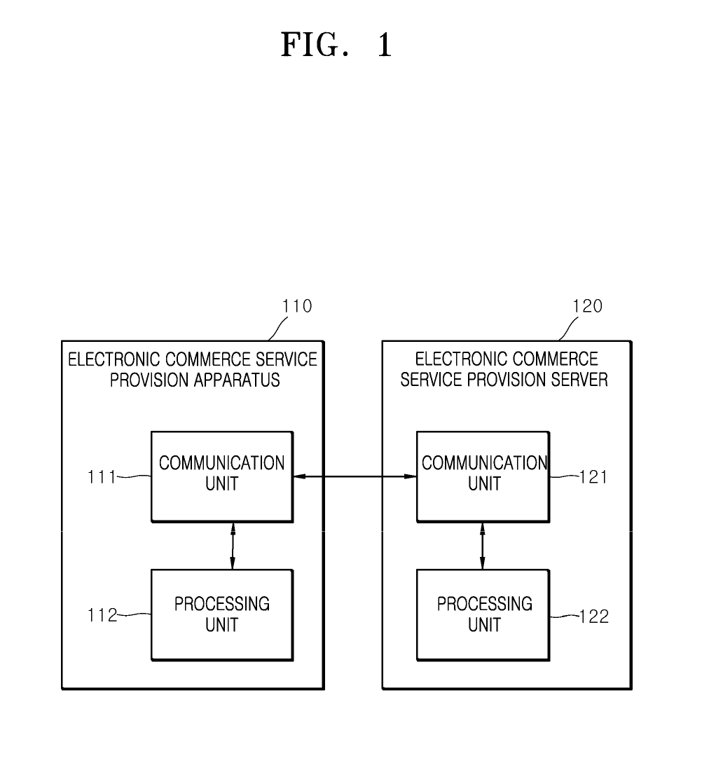

FIG. 1 is a block diagram of an apparatus and a server for providing an electronic commerce service according to an exemplary embodiment of the present invention.

An electronic commerce service according to an exemplary embodiment of the present invention may be implemented by only an electronic commerce service provision apparatus 110 or may be implemented through communication between the electronic commerce service provision apparatus 110 and an electronic commerce service provision server 120.

The electronic commerce service may be a service, such as an electronic wallet, that is used for a payment at a service provision place, and the service requires personal verification for a payment. When a plurality of service users simultaneously use the electronic commerce service, personal verification procedures performed for payments of all the service users degrade the usability of an electronic wallet and the like. Therefore, a personal verification procedure is adjusted using the service use information relationship, so that the usability of the service use can be improved. Also, since an error may occur during a process in which a service user inputs service use information, service use context between service users who have the service use information relationship is identified using the service use information relationship, so that a payment error can be prevented. A process of searching for another service user who has the service use information relationship or service use information processing for the service users having the service use information relationship may be performed by only the electronic commerce service provision apparatus 110 or the electronic commerce service provision apparatus 110 and the electronic commerce service provision server 120. A subject that implements the process may vary according to a setting of a service provider or an environment. Identical components of the electronic commerce service provision apparatus 110 or the electronic commerce service provision server 120 may correspond to each other. Identical components implemented in the electronic commerce service provision apparatus 110 or the electronic commerce service provision server 120 may are implemented by different devices, but detailed descriptions of the configuration thereof correspond to each other. Also, processes required to provide a service other than a process described below correspond to processes performed in a conventional service provision system.

The electronic commerce service provision apparatus 110 and the electronic commerce service provision server 120 will be separately described below.

The electronic commerce service provision apparatus 110 according to an exemplary embodiment of the present invention includes a communication unit 111 and a processing unit 112. One or more storage units may be further included.

The electronic commerce service provision apparatus 110 may be a terminal of a service user or a terminal of a service provider. Alternatively, the electronic commerce service provision apparatus 110 may be a device installed at a service provision place. When the electronic commerce service provision apparatus 110 is implemented with a terminal, the electronic commerce service provision apparatus 110 can be implemented through an application.

The communication unit 111 receives service use information of one service user, or transmits a request to the server to search for another service user who has the service use information relationship with a service user whose service use information has been received and receives the corresponding search result.

More specifically, the communication unit 111 receives service use information of one service user who uses the service. The service use information is information on service use and may include an identifier (ID) or location information of the user, membership information, information on a service that is or has been used by the user, a contact list of the user, information on whether the user is a group service user or whether a group service is used, information on a service provider or a service provision place, and the like. The communication unit 111 may receive an input of the user or receive service use information from the outside through wired or wireless communication. In order for the server to search for another service user who has the service use information relationship with the service user whose service use information has been received, the communication unit 111 may transmit the corresponding search request to the server and receive the corresponding search result. Alternatively, the communication unit 111 may receive a processing result from the server. The communication unit 111 may be a communication unit of a terminal.

The processing unit 112 searches for another service user who has the service use information relationship with the service user whose service use information has been received, or requests the server to search for another service user who has the service use information relationship with the service user whose service use information has been received.

More specifically, the processing unit 112 searches for another service user who has the service use information relationship with the service user whose service use information has been received by the communication unit 111. The service use information relationship is set between service users who can be determined as one group of service users. When there are one service user and other service users who can be determined as group service users, the processing unit 112 searches another service user who has the service use information relationship using service use information of the single service user to provide the service to the service users as group service users. The search may be performed in the electronic commerce service provision apparatus 110 or through the server. When the search is performed through the server, the server is requested through the communication unit 111 to search for another service user who has the service use information relationship with the service user whose service use information has been received.

The service use information relationship may be set between service users when the service users are determined to have used the group service, to have been registered in each other's contact lists, to be located together at a service provision place in the same timeslot, or are determined by themselves to have the service use information relationship with each other. The service use information relationship is set between service users who can be determined as one group of service users, and to determine service users as one group of service users, it is determined whether the service users have used the group service, have been registered in each other's contact lists, or are located together at a service provision place in the same timeslot, or it is determined by the service users whether the service users have the service use information relationship with each other. When the service users have used the group service, the service users may be given the service use information relationship and determined as group service users. When the service users have been registered in each other's contact lists, the service users are determined as acquaintances each other, and the service use information relationship may be set between the service users. Contact lists stored in terminals may be used as the contact lists. When the service users are located together at a service provision place in the same timeslot, it is determined that the service users are visiting the place together, and the service use information relationship may be set between the service users. The same timeslot may be in a range of time that is consumed to sequentially use a service for payment or the like. For example, the same timeslot may be set to five minutes, thirty minutes, or the like. Alternatively, if tagging or beacon recognition is performed after the arrival of one service user at a service provision place and it is determined through tagging or beacon recognition after the arrival of another service user at the service provision place where the other service user has arrived at the same service provision place, it is possible to request a check of the service use information relationship between the two users or set the service use information relationship. Arrival at the field can be recognized by tagging with a quick response (QR) code, near field communication (NFC) tagging, a barcode, etc., or using a beacon, etc. which is capable of wireless communicating with a terminal and installed at the field. If arrival at a service provision place is recognized through tagging and beacon communication, a timeslot from when one service user arrives at the service provision place in the above-described manner until the single service user goes out of the service provision place or finishes a payment and a timeslot from when another service user arrives at the service provision place and tagging or beacon recognition is performed until the other service user goes out of the service provision place or finishes a payment may be determined to be identical. The time and the location can be determined using a global positioning system (GPS), etc. of terminals.

When there is another user (a second user) having the service use information relationship with a first user, a process in which the first user becomes a group service user together with the second user may involve a grouping request and checking procedure. The grouping request and checking procedure is a grouping request and intention checking procedure for service use in which when the first user designates the second user and sends a grouping request, information of the first user is shown to the second user and the second user checks the first user and then accepts grouping. This procedure may vary according to a level of the service use information relationship. For example, when the service use information relationship between the two users is determined to be a grouping-requirement threshold value or more, the second user may be automatically accepted as a group service user of the first user. Also, according to a set threshold value and a derived service use information relationship, only a grouping request may be automatically shown to a user, and a final intention of whether to accept grouping may be received from each user.

When it is determined that there is the service use information relationship between service users through inputs of the service users or a service provider, the service use information relationship is set between the service users, and the service users may be determined as group service users.

Service users who are determined as group service users can not only make a group order and payment but also can make remittance to each other. For remittance, security and authentication steps can be adjusted. When a user of a remittance service has a history of remittance to a counterpart to whom the user intends to make remittance and the service use information relationship corresponding to a safe threshold value or more is derived from the history, for example, there is a pattern of periodical remittance of a predetermined amount, a personal verification procedure additionally performed in a remittance step of the user is set to be omitted. Alternatively, when the service use information relationship corresponding to the safe threshold value or more is derived from a user who receives an acknowledgement of remittance and a user who has made the remittance, it is possible to omit an additional personal verification procedure in a remittance acceptance step, that is, a step of finally receiving remittance to the user's own account. Alternatively, when there is a history of remittance between two users and the service use information relationship corresponding to the safe threshold value or more is derived from the history, a personal verification procedure additionally performed for remittance between the two users may be set to be omitted. In this way, the service use information relationship used for a remittance service may be generated according to location-based information. In other words, the service use information relationship used for a remittance service may be set between the users when users are recognized to be at one place at the time point of remittance, that is, when the users may be determined to face each other.

In the case of a remittance service, when a user designates a counterpart user to whom the user intends to make remittance and inputs a remittance, it is possible to determine whether there is a statistically-meaningful pattern in relation to the counterpart user. When there is a meaningful pattern, it is determined whether the remittance deviates from a past remittance pattern corresponding to the counterpart user. In other words, when service use information is analyzed to indicate a past remittance pattern in which less than one hundred thousand won has been mainly sent, one million won input as a remittance may be determined as an abnormal transaction. This may be determined as an attempt to send a large amount of money caused by illegal use of banking information of the user or as the user's mistake of inputting a wrong amount of money. When an abnormal transaction is sensed, an additional personal verification procedure may be performed, or a check for the remittance may be requested. According to a remittance counterpart, a remittance determined as an abnormal transaction may vary. For example, remittance of one hundred thousand won or more may be determined as an abnormal transaction for a counterpart A but may be determined as a normal transaction for a counterpart B. When remittance is determined as a normal transaction, no additional personal verification procedure is performed, and no check for a remittance is requested. Using such service use information varying according to a counterpart, it is possible to sense an abnormal transaction of the corresponding user.

Meanwhile, the service use information relationship may be generally set between service users when the service users have used the service at one or more common service provision places and the use of the service at the places corresponds to the use of the group service. The service use information relationship may be checked through histories of past purchase and set between service users. When service users have used the service at one or more common service provision places and the use of the service at the places corresponds to the use of the group service, the service use information relationship may be set. When there is a history of use of the service at one or more common places and the history of use of the service is not accidental but corresponds to the use of the group service, the service use information relationship may be set between the corresponding service users. When a history of use of the service at a common place is repeated or a history of use of the service at a plurality of places is repeated, the service use information relationship may be set.

A correlation analysis on whether places where the service is used in the same timeslot are identical is performed on the basis of the service users' histories of use of the service, and when a result value derived from the correlation analysis is a threshold value or more, the service use information relationship may be set between the service users. A correlation analysis may be used to derive an objective service use information relationship. To check the service use information relationship using past service use information, when it is determined from the service users' histories of use of the service that places where the service is used in the same timeslot are identical, it may be determined whether the service users were at the same place in the same timeslot due to a service use relationship or the places were identical by accident. To this end, a correlation analysis is performed on past information that the service users were at the same place in the same time slot, and when a result value derived from the correlation analysis is the threshold value or more, the service use information relationship may be set between the service users. A correlation between pieces of service use information of the service users is calculated through the correlation analysis, and when a result value derived from the correlation analysis is the threshold value or more, the service use information relationship may be set between the service users. The correlation analysis may be performed through a Cohen's Kappa analysis.

When there is another user who has the service use information relationship, a security procedure for service use of the service user who has the service use information relationship is adjusted by one or more steps or maintained.

More specifically, since service users who have the service use information relationship can provide safety by checking each other, a security procedure for service use is adjusted by one or more steps or maintained for the service users. A security procedure for service use may be adjusted for all or some of service users. In other words, when a security procedure for one person is completed, it is possible to maintain or omit a personal verification procedure for other service users. On the other hand, when no service use information relationship is found, a personal verification procedure may be maintained or added to provide a safe service. When safety is ensured, one or more steps of a security procedure may be omitted, or the security procedure may be maintained. When safety is not ensured, one or more steps of a security procedure may be added, or the security procedure may be maintained. When a security procedure is performed by the electronic commerce service provision apparatus, the security procedure may be adjusted by the electronic commerce service provision apparatus. When a security procedure is performed by the electronic commerce service provision server, the security procedure may be adjusted by the electronic commerce service provision server. An adjustment of a security procedure may vary according to types and the number of security procedures for service use.

For example, when three acquaintances are connected and simultaneously make purchases at a field and the corresponding purchase information and steps are shared, it is possible to determine, through meeting or confrontation among the purchasers, that an electronic wallet of a terminal which is currently making a payment is not being illegally used by another person. Therefore, unlike a case in which a purchaser solely uses the service, a personal verification procedure may be adjusted or reduced and performed. Contrary to cooperative buying, in the case of sole buying, a personal verification procedure may be relatively reinforced.

As a detailed example, among electronic wallet or electronic commerce functions, there may be a function for automatically registering users as cooperative buyers of acquaintances with each other when the users have a history of purchase in common or have been registered in each other's contact lists. In this case, there is a method of checking a relationship in which a step of the users registered as cooperative purchasers who share a purchase step according to the function can be used as a security method for verification between acquaintances instead of personal verification when a payment is made later. Here, a personal verification step is adjusted according to the ensured relationship.

A case in which purchaser 1, purchaser 2, and purchaser 3 have a predetermined number or more of experiences of cooperative buying at store A, store B, and store C is described as an example.

In this case, purchaser 1, purchaser 2, and purchaser 3 may have used store A, store B, and store C due to a certain inevitable condition. The purchasers may belong to the same department in the same office and have visited restaurants or food and beverage stores close to the office. In this case, purchaser 1, purchaser 2, and purchaser 3 may be recommended as cooperative buyers of acquaintances and connected, and a security checkup step may be adjusted.

However, purchaser 1, purchaser 2, and purchaser 3 may be members of the same organization even with no relationship or may have only been registered in each other's contact lists as members of the same organization. Therefore, it is possible to consider that the visits to store A, store B, and store C close to the same building in the same timeslot have been made by accident. In this case, it is inappropriate to recommend that purchaser 1, purchaser 2, and purchaser 3 be connected as cooperative buyers, and purchaser 1, purchaser 2, and purchaser 3 should not perform personal verification with each other even when purchaser 1, purchaser 2, and purchaser 3 are connected as cooperative buyers.

When one statistical quantization method is used, it is possible to determine whether common histories of purchase have been made by accident or due to the inevitability of a relationship between acquaintances within a statistical error range using statistical data of each purchaser's visits to each store. Among the methods, there is a method of calculating a Cohen's Kappa coefficient of each combination of two persons and using a calculated value from which a portion of coincidence is removed in common decision making. It is possible to calculate a Cohen's Kappa coefficient of each combination of two persons and determine that common histories of purchase have been made by a selection of intentional agreement between purchasers only when Cohen's Kappa coefficients are equal to or greater than a set threshold value. Therefore, common histories of purchase may be determined to have been made due to a relationship between acquaintances, and the purchasers can be connected as cooperative buyers and perform personal verification with each other, so that a purchase procedure can be performed.

Examples of calculation of a Cohen's Kappa coefficient are described below.

Using statistical data in which purchasers 1, 2 and 3 have histories of use of stores A, B and C in the same timeslot, it is possible to make a statistical and quantitative measurement through a Cohen's Kappa coefficient in order to determine whether purchaser 1 and purchaser 2 simultaneously made visits by intention due to a relationship between acquaintances or by accident. When purchaser 1 and purchaser 2 have the following numbers of purchases at stores A, B and C in the same timeslot, Cohen's Kappa coefficients can be calculated as follows.

TABLE 1

| | Purchaser 2A | Purchaser 2B | Purchaser 2C |
|---|---|---|---|
| Purchaser 1A | 1 | 2 | 1 |
| Purchaser 1B | | 2 | 1 |
| Purchaser 1C | | 1 | 2 |

Pr(a)=(1+2+2)/10=0.5

1A=4/10=0.4,1B=3/10=0.3,1C=3/10=0.3

2A=1/10=0.1,2B=5/10=0.5,2C=4/10=0.4

→Pr(e)=(1A*2A)+(1B*2B)+(1C*2C)=0.04+0.15+0.12=0.31

Coefficient K=(Pr(a)−Pr(e))/(1−Pr(e))=(0.5−0.31)/(1−0.31)=0.275 Equation 1:

Using statistical data in which purchasers 1, 2 and 3 have histories of use of stores A, B and C in the same timeslot, it is possible to make a statistical and quantitative measurement through a Cohen's Kappa coefficient in order to determine whether purchaser 1 and purchaser 3 simultaneously made visits by intention due to a relationship between acquaintances or by accident. When purchaser 1 and purchaser 3 have the following numbers of purchases at stores A, B and C in the same timeslot, Cohen's Kappa coefficients can be calculated as follows.

TABLE 2

| | Purchaser 3A | Purchaser 3B | Purchaser 3C |
|---|---|---|---|
| Purchaser 1A | 2 | | 1 |
| Purchaser 1B | | 4 | 1 |
| Purchaser 1C | | | 2 |

Pr(a)=(2+4+2)/10=0.8

1A=3/10=0.3,1B=5/10=0.5,1C=2/10=0.2

3A=2/10=0.2,3B=4/10=0.4,3C=4/10=0.4

→Pr(e)=(1A*3A)+(1B*3B)+(1C*3C)=0.06+0.2+0.08=0.34

Coefficient K=(Pr(a)−Pr(e))/(1−Pr(e))=(0.8−0.34)/(1−0.34)=0.697 Equation 2:

A Cohen's Kappa coefficient calculated from the histories of purchase of purchaser 1 and purchaser 2 is 0.275, and when the threshold value is 0.5, it is difficult to determine that visits of purchaser 1 and purchaser 2 are intentional simultaneous visits of acquaintances. On the other hand, a Cohen's Kappa coefficient calculated from the histories of purchase of purchaser 1 and purchaser 3 is 0.697, and it is statistically determined that visits of purchaser 1 and purchaser 3 are intentional simultaneous visits of acquaintances. On the basis of this determination, when purchaser 1 and purchaser 3 simultaneously visit a store, it is determined that the two purchasers can perform personal verification with each other by confrontation. Therefore, it is possible to determine that an electronic wallet terminal is safely used by the owner, and connection of the purchasers is recommended. When the purchasers are connected, a personal security verification procedure is adjusted or reduced. On the other hand, when a Cohen's Kappa coefficient is less than the threshold value, it is determined that histories of two purchasers are close to accidental simultaneous visits to a store. Also, it is determined that the two purchasers cannot check whether terminals of the two purchasers are their own, and a personal security verification step is not adjusted or is reinforced.

In addition, common purchase information may be logically and arithmetically determined to recommend connection for cooperative buying between acquaintances and adjust a security level. As an example of arithmetically determining a relationship, purchasers who share their contact lists may calculate a relationship by comparing differences between the numbers of persons who have been connected as common purchasers according to histories when using the same store and the numbers of persons who have not been connected as common purchasers, and determine whether it is possible to perform security authentication of acquaintances. As an example of logically determining a relationship, it is possible to adjust a security procedure not by comparing purchaser's histories of past purchase but by in-person verification with confrontation between purchasers. When purchaser 1 has underwent a personal verification procedure, a function of adjusting a personal verification procedure of purchaser 2 connected to purchaser 1 may be provided. Alternatively, a particular user or a user may be set, and a function of adjusting a security procedure may be provided when a user is connected to the user.

The service use information relationship may also be derived from an already-formed group.

When there is another service user who has the service use information relationship, it is determined whether an abnormal pattern is in service use information received by the communication unit 111 using a service use information prediction value derived from past service use information of the service users who have the service use information relationship.

More specifically, when there is another service user who has the service use information relationship, it is determined whether an abnormal pattern is in service use information input from a service user or received by the communication unit 111 using a service use information prediction value derived from past common service use information of service users who have the service use information relationship. To determine whether an abnormal pattern is in current service use information using past service use information, common service use information in past service use information of a plurality of service users is used. Since it is possible to obtain objectivity from the past common service use information of the plurality of service users and perform cross-checking, safety can be improved.

A reference for determining whether service use information is correct using a service use information prediction value derived from past common service use information of service users who have the service use information relationship is set, and when the prediction value deviates from the reference, it is determined that there is an error in the service use information. The service use information prediction value may be obtained through a T-test or an analysis of variance (ANOVA) test.

Whether an abnormal pattern is in the service use information may be determined by the electronic commerce service provision apparatus or the electronic commerce service provision server. A subject that determines whether an abnormal pattern is in the service use information may vary according to a setting of a service provider or an environment.

When it is determined that the received service use information shows an abnormal pattern, it is possible to request the corresponding service user to check the service use information or re-input service use information, adjust a security procedure, such as a personal verification or the like, by one or more steps, or maintain the security procedure. When the received service use information deviates from the reference obtained from the service use information prediction value, it is determined that the received service use information shows an abnormal pattern, and it is possible to request the corresponding service user to check the service use information or re-input service use information, adjust a security procedure by one or more steps, or maintain the security procedure. In various cases, an abnormal pattern may be shown in service use information. Service use information may be distorted or an error may occur in service use information due to the service user's mistake of inputting wrong service use information, a security attack, such as hacking, or a third party's attempt to use the service. Therefore, when it is determined that an abnormal pattern is in the received service use information, it is possible to request the corresponding service user to check the service use information or re-input service use information, adjust a security procedure by one or more steps, or maintain the security procedure. In order to determine that the abnormal pattern is just an input error, it is possible to request the service user to check the service use information or re-input service use information, or in order to improve the safety of service use, it is possible to adjust a security procedure by one or more steps or maintain the security procedure.

The security procedure may be adjusted on the basis of the service use information relationship. In other words, the service use information relationship or a service use information prediction value may be provided as a weighting factor for detecting, analyzing, and calculating whether there is an irregularity in a banking transaction of the corresponding group service user, and the security procedure may be adjusted according to an analysis result of the banking transaction. Conversely, an analysis result of a banking transaction may be applied to derive the service use information relationship, and the security procedure may be adjusted according to the derived service use information relationship.

Each piece of purchase information of purchasers who are acquaintances is used in a logical, arithmetical, and statistical manner to identify context or calculate a common feature and an average, and it is determined whether the context and the calculated values deviate from an allowable range or a threshold value. Then, a payment error prevention and security procedure is adjusted. Context is situational information and refers to information that can be obtained from any situation being enacted, that is, information derived from service use information of service users who have the service use information relationship. The context may be obtained from a service use information prediction value derived from service use information of service users and becomes a criterion for determining whether service use information is correct. The service use information used to obtain the context may be past or current service use information. The context may be the same value as the service use information prediction value, a condition derived from the service use information prediction value, or the like.

As a detailed example, when a plurality of purchasers manually input a payment or a unit of purchase in their electronic wallets and electronic commerce programs, for example, when purchaser 1, purchaser 2 and purchaser 3 respectively input 1, 2 and 33, it is possible to determine a probability that purchaser 3 made the input by mistake in view of the context of the acquaintances' input values using various methods and perform a procedure for determining whether purchaser 3 made the input by mistake as a method of preventing a numerical input error. In one statistical method among the various methods, an average and a standard deviation are used. In this case, an average of 12 and a standard deviation of 14.85 are calculated. Since purchaser 3 input the value deviating from a standard deviation range of −2.85 to 26.85, it is determined that purchaser 3 probably input 33 by mistake in the current purchase situation, and it is possible to request purchaser 3 to check the input. Here, when purchasers have sufficient histories of cooperative buying of the corresponding target of purchase, only data which does not show a statistically-meaningful difference in purchase information of each purchaser is recognized as common context through a T-test or an ANOVA test, and context that the purchasers do not make input values having a large statistical difference is set, so that the present error prevention procedure may be performed only when another input having a large difference is made. As a detailed example, an average and a deviation of values input by each of purchaser 1 and purchaser 3 may be calculated using histories of purchase of purchaser 1 and purchaser 3, and it may be determined through a T-test whether there is a statistically-meaningful difference in input value between purchaser 1 and purchaser 3. When there has been no statistically-meaningful difference, it is highly likely that the input of 33 made by purchaser 3 is an input error, and thus a checking procedure may be added for safe input.

An example of a T-test is described below.

Purchase amounts of purchaser 1 and purchaser 2 are compared using a T-test to generate common context of the two connected purchasers as follows.

TABLE 3

| Purchase amount of Purchaser 1 | Purchase amount of Purchaser 2 |
|---|---|
| 5000 | 5500 |
| 5500 | 5000 |
| 6000 | 4000 |
| 4000 | 4000 |
| 5000 | 5000 |
| 5000 | 6000 |
| 5500 | 4500 |
| 4000 | 4500 |
| 5000 | 5000 |

A paired T-test is as follows.

TABLE 4

| | Purchase amount | Purchase amount |
|---|---|---|
| | of Purchaser 1 | of Purchaser 2 |
| Average | 5000 | 4833.333333 |
| Variance | 437500 | 437500 |
| Number of observation times | 9 | 9 |
| Pearson correlation | 0.071428571 | |
| coefficient | | |
| Assumption average | 0 | |
| difference | | |
| Degree of freedom | 8 | |
| t statistic | 0.554700196 | |
| P(T <= t) one-sided test | 0.297132008 | |
| t rejection point one-sided test | 1.859548038 | |
| P(T <= t) two-sided test | 0.594264016 | |
| t rejection point two-sided | 2.306004135 | |
| test | | |

Since a P value among these result values is 0.594264016 and greater than a threshold value of 0.05, it is possible to make a conclusion that the two purchasers have made purchases with statistically-similar purchase amounts and to generate common context of a purchase amount that can be used as a criterion of safe payment between the two purchasers. One example of using the common context of a purchase amount when the two purchasers are connected later to make purchases is as follows. Purchase context of the two purchasers indicates that there is no significant difference in purchase amount between the two purchasers. Here, when purchaser 1 inputs 5000 and purchaser 2 inputs 15000, the input values deviate from the criterion that there is generally no significant difference between amounts input by the two purchasers. Therefore, in this case, purchaser 2 may be caused to perform a procedure for checking the input amount.

An example of an ANOVA test is described below.

Purchase quantities of purchaser 1, purchaser 2 and purchaser 3 are compared using an ANOVA test to generate common context of the three connected purchasers as follows.

TABLE 5

| Purchase quantity of | Purchase quantity of | Purchase quantity of |
|---|---|---|
| Purchaser 1 | Purchaser 2 | Purchaser 3 |
| 63 | 73 | 82 |
| 68 | 88 | 90 |
| 87 | 81 | 81 |
| 53 | 71 | 85 |
| 75 | 81 | 74 |
| 58 | 48 | 76 |
| 69 | 81 | 75 |
| 33 | 81 | 81 |
| 61 | 83 | 76 |
| 58 | 76 | 82 |
| 46 | 77 | 83 |
| 45 | 69 | 82 |
| 67 | 62 | 72 |
| 63 | 65 | 81 |
| 67 | 75 | 79 |
| 66 | 60 | 75 |
| 60 | 90 | 77 |
| 86 | 59 | 79 |
| 65 | 76 | 74 |
| 84 | 74 | 81 |

Results of a one-way ANOVA are as follows.

TABLE 6

| Level of factor | Number of observations | Total | Average | Variance |
|---|---|---|---|---|
| Purchase quantity | 20 | 1274 | 63.7 | 182.2211 |
| of Purchaser 1 | | | | |
| Purchase quantity | 20 | 1470 | 73.5 | 111.4737 |
| of Purchaser 2 | | | | |
| Purchase quantity | 20 | 1585 | 79.25 | 19.35526 |
| of Purchaser 3 | | | | |

TABLE 7

| Factor of | | Degree of | | | | F rejection |
|---|---|---|---|---|---|---|
| change | Square sum | freedom | Square average | F ratio | P value | point |
| Processing | 2472.7 | 2 | 1236.35 | 11.88608 | 0.00005 | 3.158843 |
| Residual | 5928.95 | 57 | 104.0167 | | | |
| Total | 8401.65 | 59 | | | | |

Since a P value among these result values is 0.00005 and smaller than the threshold value of 0.05, it is possible to make a conclusion that the three purchasers have made purchases with statistically-different purchase quantities, and it is not possible to generate common context of a purchase quantity that can be used as a criterion safe payment between the three purchasers. Therefore, in this case, even when one of the three purchasers inputs a quantity drastically different than other purchasers, a check for re-input is not performed on the basis of the present context.

Another example of an ANOVA test is described below.

Purchase quantities of purchaser 1, purchaser 2 and purchaser 3 are compared using an ANOVA test to generate common context of the three connected purchasers as follows.

TABLE 8

| Purchase quantity of | Purchase quantity of | Purchase quantity of |
|---|---|---|
| Purchaser 1 | Purchaser 2 | Purchaser 3 |
| 4 | 3 | 3 |
| 3 | 4 | 4 |
| 4 | 2 | 2 |
| 5 | 4 | 4 |
| 2 | 5 | 3 |
| 2 | 2 | 4 |
| 3 | 3 | 3 |
| 2 | 2 | 3 |

Results of a one-way ANOVA are as follows.

TABLE 9

| Level of factor | Number of observations | Total | Average | Variance |
|---|---|---|---|---|
| Purchase quantity | 8 | 25 | 3.125 | 1.267857 |
| of Purchaser 1 | | | | |
| Purchase quantity | 8 | 25 | 3.125 | 1.267857 |
| of Purchaser 2 | | | | |
| Purchase quantity | 8 | 26 | 3.25 | 0.5 |
| of Purchaser 3 | | | | |

TABLE 10

| Factor of | | Degree of | Square | | | F rejection |
|---|---|---|---|---|---|---|
| change | Square sum | freedom | average | F ratio | P value | point |
| Processing | 0.083333 | 2 | 0.041667 | 0.041176 | 0.959737 | 3.4668 |
| Residual | 21.25 | 21 | 1.011905 | | | |
| Total | 21.33333 | 23 | | | | |

Since a P value among these result values is 0.959737 and greater than the threshold value of 0.05, it is possible to make a conclusion that the three purchasers have made purchases with statistically-similar purchase quantities, and it is possible to generate common context of a purchase quantity that can be used as a criterion of safe payment among the three purchasers. One example of using the common context of a purchase quantity when the three purchasers are connected later to make purchases is as follows. Purchase context of the three purchasers indicates that there is no significant difference in purchase quantity between the three purchasers. Here, when purchaser 1 inputs 3 and purchaser 3 inputs 33, the input values deviate from the criterion that there is generally no significant difference between purchase amount input by the three purchasers. Therefore, in this case, purchaser 3 may be caused to perform a procedure for checking the input quantity.

This is a determination method with a criterion that cannot be calculated when purchaser 3 makes a purchase solely, and in the determination method, context of a plurality of purchasers present at the same sales place is generated to make a determination. A criterion may be determined not only by the statistical method of this example but also by simply comparing differences between numbers input by purchasers.

In another example, ages in membership information of purchasers are used as purchase context. For example, when purchaser 1 is a teenager, purchaser 2 is in his or her forties, and purchaser 1 makes a purchase with a higher amount of money or a purchase of a greater quantity than purchaser 2, purchaser 1 and purchaser 2 may be caused to perform a personal verification procedure or a procedure for checking input payment information and re-inputting payment information.

The electronic commerce service provision server 120 includes a communication unit 121 and a processing unit 122, and may include one or more storage units.

The communication unit 121 receives a request to search for another service user who has the service use information relationship with a service user whose service use information has been received from the electronic commerce service provision apparatus 110 and transmits a result of the search to the electronic commerce service provision apparatus.

More specifically, the communication unit 121 receives a request to search for another service user who has the service use information relationship with the service user whose service use information has been received from the electronic commerce service provision apparatus 110. Also, the communication unit 121 may transmit a result of the search performed by the processing unit 122 to the electronic commerce service provision apparatus 110. Alternatively, the processing unit 122 may transmit a processing result.

The processing unit 122 searches for another service user who has the service use information relationship with the service user.

More specifically, the processing unit 122 searches for another service user who has the service use information relationship with the service user according to the search request received from the electronic commerce service provision apparatus 110. The service use information relationship is set between service users who can be determined as one group of service users.

When the processing unit 122 finds another service user who has the service use information relationship, the processing unit 122 adjusts a security procedure for service use of the service user who has the service use information relationship by one or more steps or maintains the security procedure. The security procedure for service use may be adjusted by the electronic commerce service provision apparatus 110 or the electronic commerce service provision server 120.

When the processing unit 122 finds another service user who has the service use information relationship, it may be determined whether there is an error in the received service use information using a service use information prediction value derived from service use information of the service users who have the service use information relationship. Using the service use information relationship, it is determined whether there is an error in the service use information. The electronic commerce service provision apparatus 110 or the electronic commerce service provision server 120 may determine whether there is an error in the service use information.

Descriptions of the electronic commerce service provision server 120 adjusting the security procedure for service use or determining whether there is an error in the service use information correspond to descriptions of the electronic commerce service provision apparatus 110 adjusting the security procedure for service use or determining whether there is an error in the service use information.

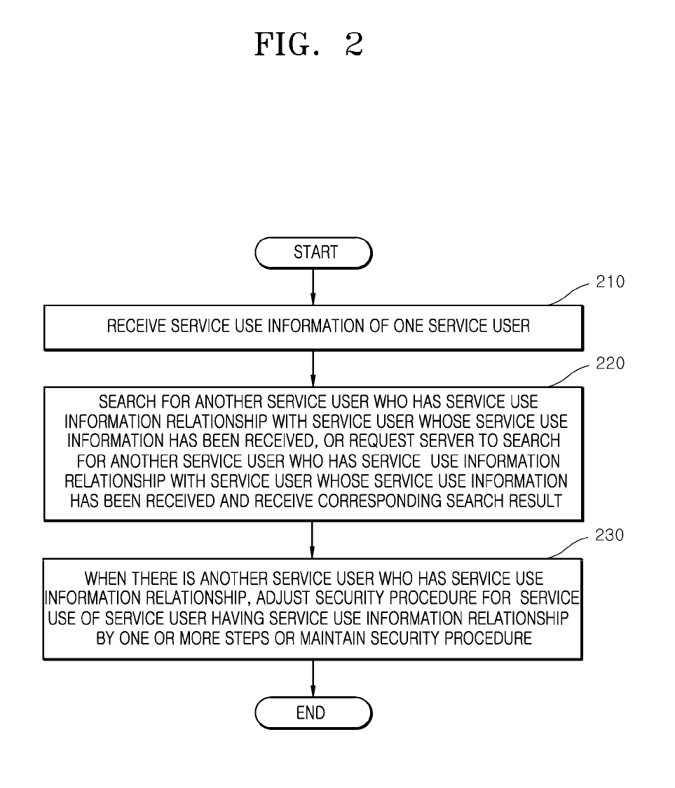

FIG. 2 is a flowchart of a method of providing an electronic commerce service according to an exemplary embodiment of the present invention, which is performed by an electronic commerce service provision apparatus.

In step 210, service use information of one service user is received.

More specifically, service use information of one service user who uses a service is received. Detailed description of this step corresponds to detailed description of the communication unit 111 of FIG. 1 and will not be reiterated.

In step 220, another service user who has a service use information relationship with the service user whose service use information has been received is searched for, or a server is requested to search for another service user who has the service use information relationship with the service user whose service use information has been received, and the corresponding search result is received.

More specifically, to expand service use information of one person to other service users who have the service use information relationship, another service user who has the service use information relationship with the service user whose service use information has been received is searched for. Since the search may be performed by the server, it is possible to request the server to search for another service user who has the service use information relationship with the service user whose service use information has been received and receive the corresponding search result.

The service use information relationship may be set between service users who can be determined as one group of service users.

The service use information relationship may be set between service users when the service users are determined to have used a group service, to have been registered in each other's contact lists, to be located together at a service provision place in the same timeslot, or are determined by themselves to have the service use information relationship with each other.

The service use information relationship may be set between service users when the service users have used the service at one or more common service provision places and use of the service at the places corresponds to use of a group service. A correlation analysis on whether the places where the service is used in the same timeslot are identical is performed on the basis of the service users' histories of use of the service, and when a result value derived from the correlation analysis is a threshold value or more, the service use information relationship may be set between the service users. The correlation analysis may be performed through the Cohen's Kappa analysis.

Detailed description of this step corresponds to detailed description of the processing unit 112 of FIG. 1 and will not be reiterated.

When another service user who has the service use information relationship is found in step 220, a security procedure for service use of the service user who has the service use information relationship is adjusted by one or more steps or maintained.

More specifically, when there is another service user who has the service use information relationship, the service use information relationship or a security procedure for one person is made shareable with other service users, so that a security procedure for service use of the service user who has the service use information relationship may be adjusted by one or more steps or maintained. For one or more of service users having the service use information relationship, one or more personal verification procedures may be omitted or added. Detailed description of this step corresponds to detailed description of the processing unit 112 of FIG. 1 and will not be reiterated.

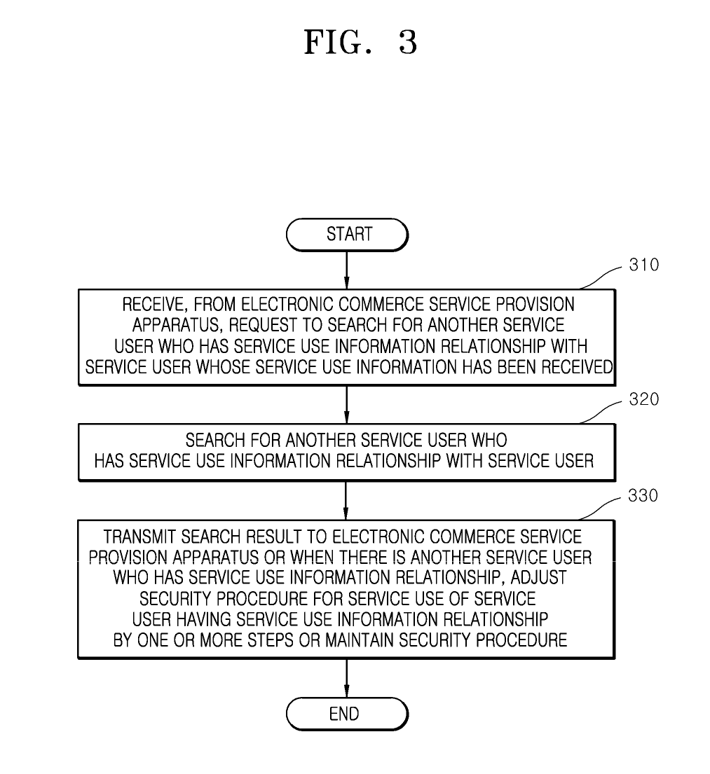

FIG. 3 is a flowchart of a method of providing an electronic commerce service according to an exemplary embodiments of the present invention, which is performed by an electronic commerce service provision server.

In step 310, a request to search for another service user who has a service use information relationship with a service user whose service use information has been received is received from an electronic commerce service provision apparatus. Detailed description of this step corresponds to detailed description of the communication unit 121 of FIG. 1 and will not be reiterated.

In step 320, another service user who has the service use information relationship with the service user is searched for. Detailed description of this step corresponds to detailed description of the processing unit 122 of FIG. 1 and will not be reiterated.

In step 330, a result of the search is transmitted to the electronic commerce service provision apparatus, or when there is another service user who has the service use information relationship, a security procedure of service use of the service user who has the service use information relationship is adjusted by one or more steps or maintained. Detailed description of this step corresponds to detailed description of the communication unit 121 and the processing unit 122 of FIG. 1 and will not be reiterated.

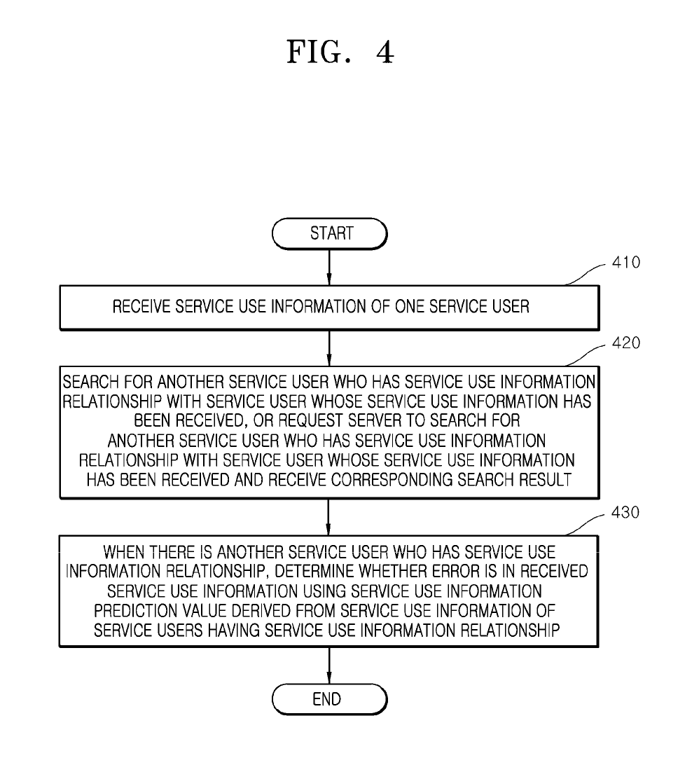

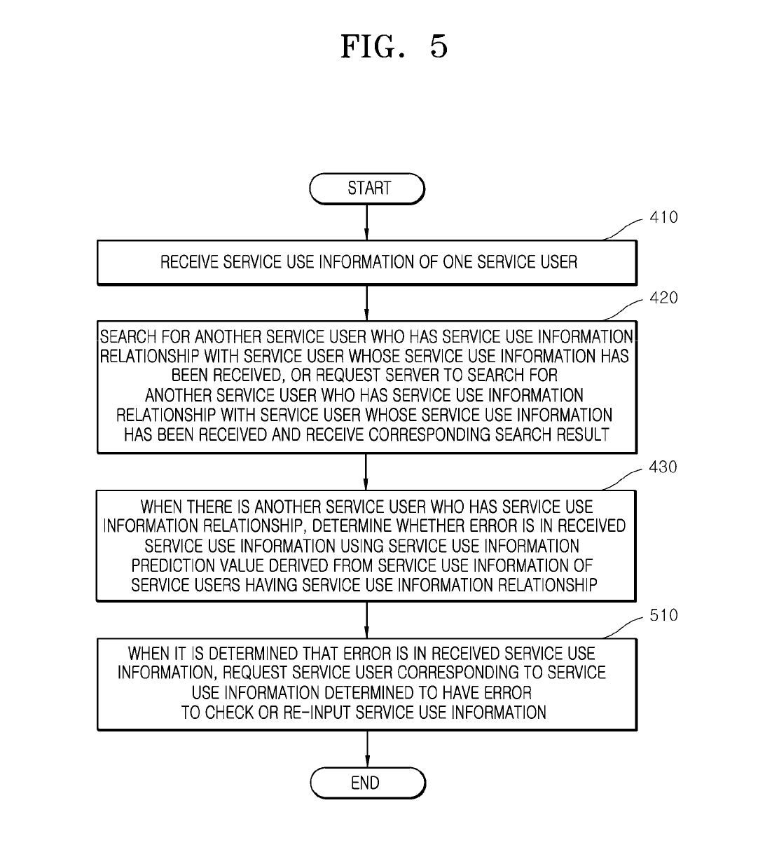

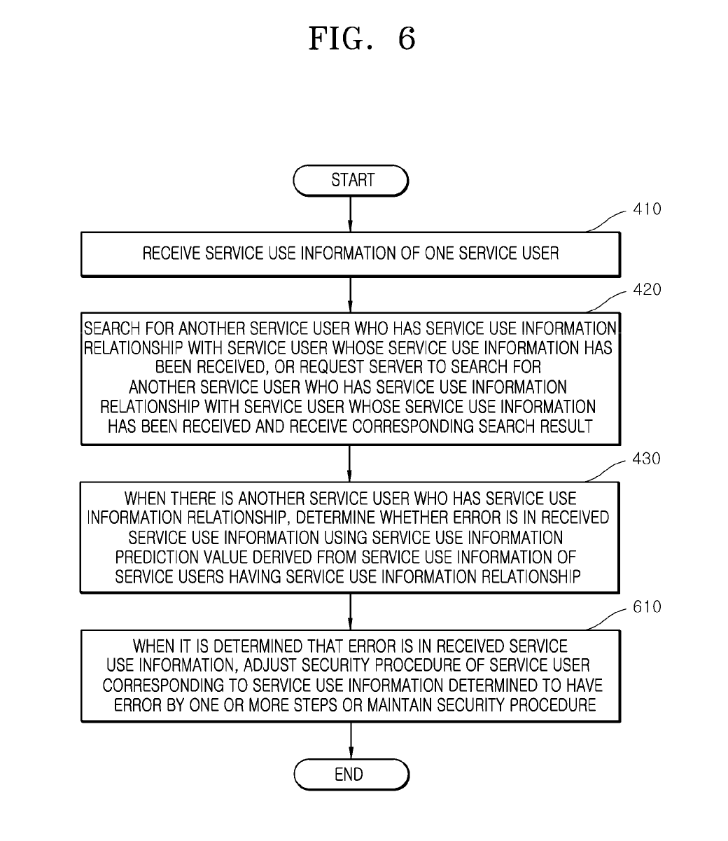

FIGS. 4 to 6 are flowcharts of methods of providing an electronic commerce service according to other exemplary embodiments of the present invention, which is performed by an electronic commerce service provision apparatus.

In step 410, service use information of one service user is received. Detailed description of this step corresponds to detailed description of step 210 of FIG. 2.

In step 420, another service user who has a service use information relationship with the service user whose service use information has been received is searched for, or a server is requested to search for another service user who has the service use information relationship with the service user whose service use information has been received, and the corresponding search result is received.

The service use information relationship may be set between service users who can be determined as one group of service users.

The service use information relationship may be set between service users when the service users are determined to have used a group service, to have been registered in each other's contact lists, to be located together at a service provision place in the same timeslot, or are determined by themselves to have the service use information relationship with each other.

When the service users have used the service at one or more common service provision places, a correlation analysis on whether the places where the service is used in the same timeslot are identical is performed on the basis of the service users' histories of use of the service, and when a result value derived from the correlation analysis is a threshold value or more, the service use information relationship is set between the service users. The correlation analysis may be performed through the Cohen's Kappa analysis.

Detailed description of this step corresponds to detailed description of step 220 of FIG. 2.

When another service user who has the service use information relationship is found in step 420, it is determined whether an error is in the received service use information using a service use information prediction value derived from service use information of the service users who have the service use information relationship.

More specifically, it is determined whether an error is in the service use information using the service use information relationship. To improve objectivity and safety, a service use information prediction value is derived from service use information of a plurality of service users, and it is determined whether an error is in the received service use information using the service use information prediction value. The service use information prediction value may be obtained through a T-test or an ANOVA test. Detailed description of this step corresponds to detailed description of the processing unit 112 of FIG. 1 and will not be reiterated.

In step 510, when it is determined that an error is in the received service use information, the service user corresponding to the service use information which is determined to have an error is requested to check the service use information or re-input service use information.

More specifically, when it is determined that an error is in the received service use information, the service user corresponding to the service use information which is determined to have an error may be requested to check the service use information or re-input service use information. Since wrong service use information may be input or an error may occur during a receiving process, the service user may be requested to check the service use information. Detailed description of this step corresponds to detailed description of the processing unit 112 of FIG. 1 and will not be reiterated.

In step 610, when it is determined that an error is in the received service use information, a security procedure of the service user corresponding to the service use information which is determined to have an error is adjusted by one or more steps or maintained.

More specifically, a security procedure of the service user corresponding to the service use information which is determined to have an error may be adjusted by one or more steps or maintained. When a third party tries to use the service or there is the risk of a security attack, such as hacking, a security procedure of the service user corresponding to the service use information which is determined to have an error may be adjusted by one or more steps or maintained. Detailed description of this step corresponds to detailed description of the processing unit 112 of FIG. 1 and will not be reiterated.

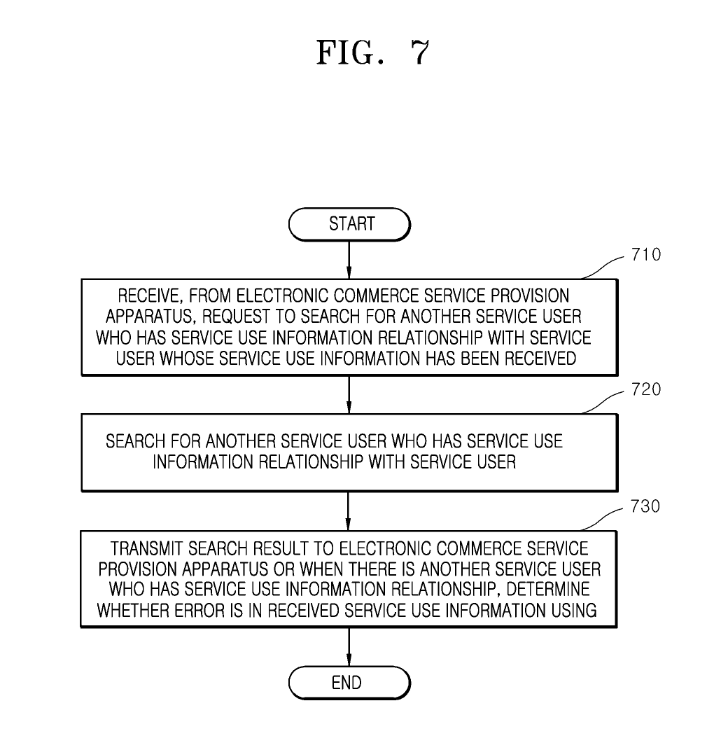

FIG. 7 is a flowchart of a method of providing an electronic commerce service according to an exemplary embodiments of the present invention, which is performed by an electronic commerce service provision server.

In step 710, a request to search for another service user who has a service use information relationship with a service user whose service use information has been received is received from an electronic commerce service provision apparatus. Detailed description of this step corresponds to detailed description of the communication unit 121 of FIG. 1 and will not be reiterated.

In step 720, another service user who has the service use information relationship with the service user is searched for. Detailed description of this step corresponds to detailed description of the processing unit 122 of FIG. 1 and will not be reiterated.

In step 730, a result of the search is transmitted to the electronic commerce service provision apparatus, or when there is another service user who has the service use information relationship, it is determined whether there is an error using a service use information prediction value derived from service use information of the service users having the service use information relationship. Detailed description of this step corresponds to detailed description of the communication unit 121 and the processing unit 122 of FIG. 1 and will not be reiterated.

Exemplary embodiments of the present invention may be implemented in the form of program instructions executable by various computing means and recorded in a computer-readable recording medium. The computer-readable recording medium may include program instructions, data files, data structures, or the like solely or in combination. The program instructions recorded in the medium may be specially designed and configured for the present invention or may be known to and used by those of ordinary skill in the computer software art. Examples of the computer-readable recording medium include magnetic media such as a hard disk, a floppy disk, and a magnetic tape, optical recording media such as a compact disc read-only memory (CD-ROM) and a digital versatile disc (DVD), magneto-optical media such as a floptical disk, and hardware devices such as a ROM, a random access memory (RAM), a flash memory, etc. specially configured to store and execute the program instructions. Examples of the program instructions include a high-level language code executable by a computer using an interpreter or the like as well as a machine language code generated by a compiler. The hardware devices may be configured to operate as one or more software modules to perform operations of the present invention, and vice versa.

Thus far, the present invention has been described with reference to specified matters, such as particular components, the limited exemplary embodiments, and the drawings, but the specified matters, the limited exemplary embodiments, and the drawings are provided to help general understanding of the present invention, and the present invention is not limited by the exemplary embodiments. Those of ordinary skill in the art to which the present invention pertains can make various changes and modifications of the descriptions.

Accordingly, the spirit of the present invention should not be limited and defined by the above-described exemplary embodiments, and it is intended that the following claims and all of equivalents to the claims and equivalent modifications fall within the scope of the present invention.

1. A method of providing an electronic commerce service, the method comprising:
receiving service use information of at least one user of an electronic commerce service;
deriving a service use information relationship from the received service use information;
forming a service user group based on the derived service use information relationship; and
completing personal verification by performing a personal verification procedure for all service users belonging to the service user group,
wherein the completing of the personal verification further comprises completing the personal verification by performing a verification procedure identical to or simpler than a basic personal verification procedure or without an additional verification procedure according to the service users based on the service use information relationship,
the electronic commerce service includes an electronic payment service, and
the service use information relationship is derived from a history in which the service user and another service user have belonged to an identical service user group and used the service in the received service use information.

2. The method of claim 1, wherein in the personal verification procedure, a payment password of a user belonging to the service user group is input, and the user is verified.

3. The method of claim 1 wherein a correlation analysis on whether places where the service is used in an identical timeslot are identical is performed based on the service users' histories of use of the service, and when a result value derived from the correlation analysis is a threshold value or more, the service use information relationship is set between the service users.

4. The method of claim 3, wherein the correlation analysis is performed through a Cohen's Kappa analysis.

5. The method of claim 1, wherein the forming of the service user group includes an acceptance checking procedure for checking an acceptance of joining the service user group, and
a number of steps constituting the acceptance checking procedure is variable based on a level of the service use information relationship.

6. A method of providing an electronic commerce service, the method comprising:
receiving, by a service provision apparatus, service use information of at least one user of an electronic commerce service;
obtaining a service use information relationship from the received service use information;
forming a service user group based on the service use information relationship; and
completing personal verification by performing a personal verification procedure for all service users belonging to the service user group,
wherein the completing of the personal verification further comprises completing the personal verification by performing a verification procedure identical to or simpler than a basic personal verification procedure or without an additional verification procedure according to the service users based on the service use information relationship,
the electronic commerce service includes an electronic payment service, and
the service use information relationship is derived from a history in which the service user and another service user have belonged to an identical service user group and used the service in the received service use information.

7. The method of claim 6, further comprising:
receiving orders from users belonging to the service user group;
analyzing service use information of the users belonging to the service user group based on the service use information relationship; and
wherein the verification procedure is more reinforced than a basic personal verification procedure for a service user who has transmitted service use information showing an abnormal pattern in common service use information of the analyzed service use information or by performing a verification procedure identical to or simpler than the basic personal verification procedure or without performing an additional verification procedure for service users who have transmitted service use information not showing an abnormal pattern in the common service use information of the analyzed service use information.

8. The method of claim 7, wherein the analyzing of the service use information comprises performing a T-test or an analysis of variance (ANOVA) test.

9. A computer-readable recording medium in which a program for causing a computer to execute the method of claim 6 is recorded.

10. An apparatus for providing an electronic commerce service, the apparatus comprising:
a communication unit configured to receive service use information of at least one user of an electronic commerce service; and
a processing unit configured to derive a service use information relationship from the received service use information, form a service user group based on the derived service use information relationship, and complete personal verification by performing a personal verification procedure for all service users belonging to the service user group,
wherein in the personal verification procedure, the personal verification is performed through a verification procedure identical to or simpler than a basic personal verification procedure or without an additional verification procedure according to the service users based on the service use information relationship,
the electronic commerce service includes an electronic payment service, and
the service use information relationship is derived from a history in which the service user and another service user have belonged to an identical service user group and used the service in the received service use information.

11. The apparatus of claim 10, wherein:
the processing unit is configured to request a server to search for a service user who has the service use information relationship with the received service use information.

12. (canceled)

13. The apparatus of claim 10, wherein:
wherein the processing unit completes the personal verification by performing a verification procedure more reinforced than a basic personal verification procedure for a service user who has transmitted service use information showing an abnormal pattern in common service use information of the analyzed service use information or by performing a verification procedure identical to or simpler than the basic personal verification procedure or without performing an additional verification procedure for service users who have transmitted service use information not showing an abnormal pattern in the common service use information of the analyzed service use information.

14. (canceled)

15. A computer-readable recording medium in which a program for causing a computer to execute the method of claim 1 is recorded.

16. The method of claim 6, wherein obtaining a service use information relationship from the received service use information comprises:
requesting a server to search for a service user who has a service use information relationship with the received service use information;
receiving a result of the search from the server; and
forming the service user group based on the received search result.

17. The apparatus of claim 10, wherein the apparatus comprises a server.
